(19) United States
(12) Patent Application Publication
(10) Pub. No.: US 2026/0238311 A1
(43) Pub. Date: Aug. 13, 2026

(54) BEAM MANAGEMENT

(71) Applicant: VIAVI Solutions Inc., Chandler, AZ (US)

(72) Inventors: Yun CHEN, Stevenage (GB); Onur DIZDAR, London (GB); Ankit GUPTA, Welwyn Garden City (GB); Stephen WANG, London (GB)

(21) Appl. No.: 19/050,243

(22) Filed: Feb. 11, 2025

(51) Int. Cl. H04B 7/06; H04W 56/00

(52) U.S. Cl. CPC H04B 7/06958; H04W 56/001

(57) ABSTRACT

In some implementations, a first wireless communication device may determine to update a model, wherein the model is configured to determine predicted layer one (L1) reference signal received powers (RSRPs) for beams included in a set A of beams and probabilities associated with the beams included in the set A of beams being included in a set B of beams. The first wireless communication device may collect training data. The first wireless communication device may determine a top-N beam distribution based on the training data. The first wireless communication device may determine the set B of beams based on the top-N beam distribution. The first wireless communication device may synchronize the set B of beams with a second wireless communication device. The first wireless communication device may update a neural network of the model based on the set B of beams.

### BACKGROUND

In some wireless communication systems, beam management may be performed to support static beamforming. In some cases, a downlink beam management procedure may consist of three stages. The first stage may include establishing an initial beam pair. The initial beam pair may include a transmit beam and a receive beam. The second stage may include refining the transmit beam. The third stage may include refining the receive beam.

### SUMMARY

Some implementations described herein relate to a method. The method may include determining, by a first wireless communication device, to update a model, wherein the model is configured to determine predicted layer one (L1) reference signal received powers (RSRPs) for beams included in a set A of beams and probabilities associated with the beams included in the set A of beams being included in a set B of beams. The method may include collecting, by the first wireless communication device, training data. The method may include determining, by the first wireless communication device, a top-N beam distribution based on the training data. The method may include determining, by the first wireless communication device, the set B of beams based on the top-N beam distribution. The method may include synchronizing, by the first wireless communication device, the set B of beams with a second wireless communication device. The method may include updating, by the first wireless communication device, a neural network of the model based on the set B of beams.

Some implementations described herein relate to a first wireless communication device. The first wireless communication device may include one or more memories and one or more processors coupled to the one or more memories. The one or more processors may be configured to determine to update a model, wherein the model is configured to determine predicted L1-RSRPs for beams included in a set A of beams and probabilities associated with the beams included in the set A of beams being included in a set B of beams. The one or more processors may be configured to collect training data. The one or more processors may be configured to determine a top-N beam distribution based on the training data. The one or more processors may be configured to determine the set B of beams based on the top-N beam distribution. The one or more processors may be configured to synchronize the set B of beams with a second wireless communication device. The one or more processors may be configured to update a neural network of the model based on the set B of beams.

Some implementations described herein relate to a non-transitory computer-readable medium that stores a set of instructions. The set of instructions, when executed by one or more processors of a first wireless communication device, may cause the first wireless communication device to determine to update a model, wherein the model is configured to determine predicted L1-RSRPs for beams included in a set A of beams and probabilities associated with the beams included in the set A of beams being included in a set B of beams. The set of instructions, when executed by one or more processors of the first wireless communication device, may cause the first wireless communication device to collect training data. The set of instructions, when executed by one or more processors of the first wireless communication device, may cause the first wireless communication device to determine a top-N beam distribution based on the training data. The set of instructions, when executed by one or more processors of the first wireless communication device, may cause the first wireless communication device to determine the set B of beams based on the top-N beam distribution. The set of instructions, when executed by one or more processors of the first wireless communication device, may cause the first wireless communication device to synchronize the set B of beams with a second wireless communication device. The set of instructions, when executed by one or more processors of the first wireless communication device, may cause the first wireless communication device to update a neural network of the model based on the set B of beams.

### BRIEF DESCRIPTION OF THE DRAWINGS

FIGS. 1A and 1B are diagrams of example an implementations associated with beam management.

FIG. 2 is a diagram of an example implementation associated with beam management.

FIG. 3 illustrates an example process for determining an updated set B of beams based on a fixed ratio of a quantity of beams included in the set B of beams to a quantity of beams included in the set A of beams.

FIG. 4 illustrates an example process for determining an updated set B of beams based on a flexible ratio of a quantity of beams included in the set B of beams to a quantity of beams included in the set A of beams.

FIG. 5 is a diagram of an example environment in which systems and/or methods described herein may be implemented.

FIG. 6 is a diagram of example components of a device associated with beam management.

FIG. 7 is a flowchart of an example process associated with beam management.

### DETAILED DESCRIPTION

The following detailed description of example implementations refers to the accompanying drawings. The same reference numbers in different drawings may identify the same or similar elements.

In some wireless communication networks, beam management may be used to support static beamforming without the requirement of dynamic channel state information (CSI) estimation. In some cases, a downlink beam management procedure consists of three stages, including initial beam pair establishment, transmit beam refinement, and receive beam refinement. To simplify the beam management process as well as reduce the signaling overhead, a network and/or a user equipment (UE) may use artificial intelligence (AI)/machine learning (ML) based beam management methods. In some cases, to implement an AI/ML based beam management procedure, neural networks may be trained to conduct spatial and temporal domain prediction with one half or less layers to predict layer 1 (L1) reference signal received power (RSRP) measurements of beams.

In some cases, two sets of beams may be determined for both spatial and temporal domain prediction. A first set of beams, Set A, consists of the targeted beams that are to be predicted by an AI/ML algorithm. A second set of beams, Set B, consists of beams that are used for beam sweeping to obtain the RSRP measurements.

In some cases, the performance of the AI/ML to predict the Set A of beams depends on the beams included in the Set B of beams. However, frequently adapting the Set B of beams may require frequent base station and UE synchronization and signaling procedures. To reduce the frequency of performing the synchronization and signaling procedures, a network may be configured to adjust the Set B of beams in a mid-term to long-term manner.

Some implementations described herein utilize an AI/ML algorithm to adapt a set B of beams. As a result, a throughput and robustness of multi-antenna wireless communication networks may be increased. Further, systems and methods described herein may be easily integrated with an existing life cycle management framework of an AI/ML model.

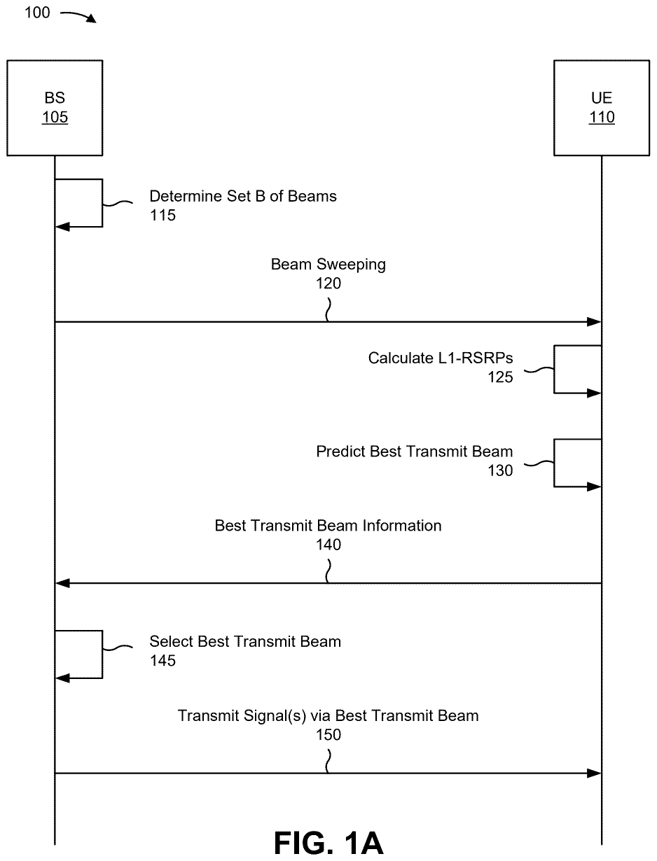

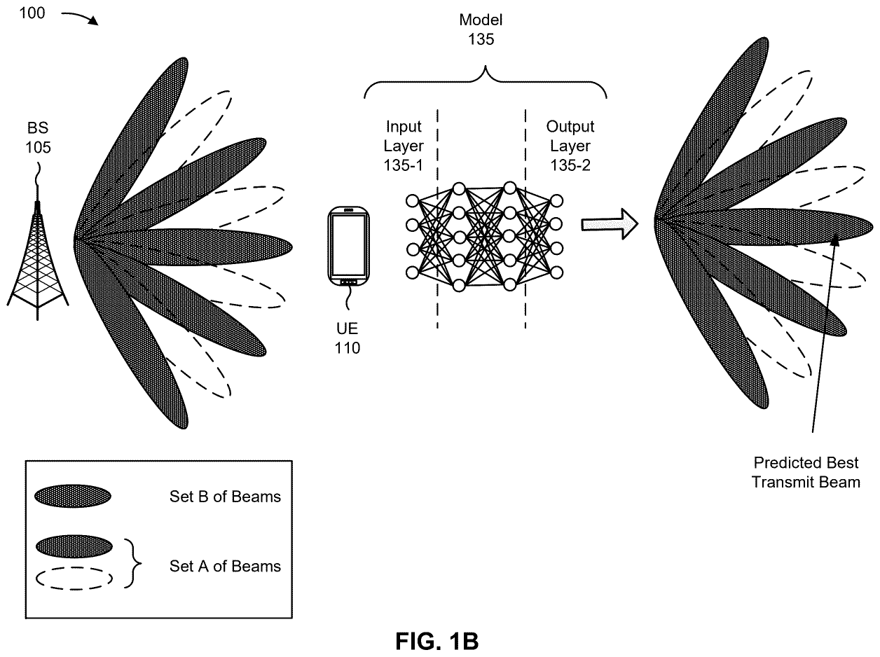

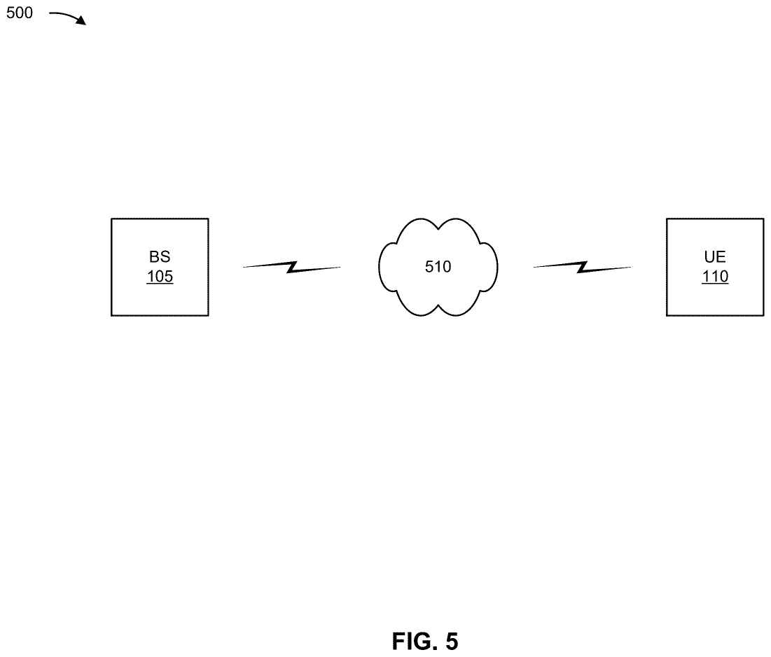

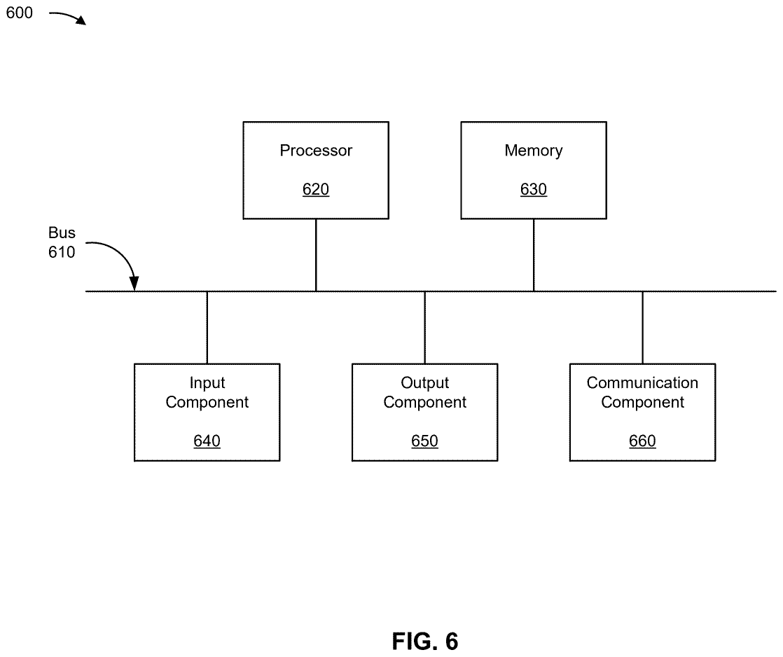

FIGS. 1A and 1B are diagrams of example implementations 100 associated with beam management. As shown in FIG. 1A, example implementation 100 includes a base station (BS) 105 and a UE 110. These devices are described in more detail below in connection with FIG. 5 and FIG. 6. In some aspects, the base station 105 and the UE 110 may communicate via a wireless communication network (e.g., network 510, described below with respect to FIG. 5).

However, the devices shown in FIGS. 1A and 1B are provided as examples, and the wireless communication network may support communication and beam management between other devices (e.g., between a UE 110 and a network node or a transmit receive point (TRP), between a mobile termination node and a control node, between an integrated access and backhaul (IAB) child node and an IAB parent node, or between a scheduled node and a scheduling node). In some aspects, the base station 105 and the UE 110 may be in a connected state (e.g., a radio resource control (RRC) connected state).

As shown by reference number 115, the base station 105 may determine a set B of beams. In some aspects, the base station 105 may determine the set B of beams based on conducting beam sweeping. In some aspects, the base station 105 may conduct beam sweeping by transmitting signals over multiple transmit beams. For example, the base station 105 may transmit, to the UE 110, channel state information reference signals (CSI-RSs) or synchronization signal blocks (SSBs) over multiple transmit beams.

In some aspects, the signals may be configured to be (e.g., using RRC signaling), semi-persistent (e.g., using media access control (MAC) control element (MAC-CE) signaling), or aperiodic (e.g., using downlink control information (DCI)). In some aspects, to enable the UE 110 to perform receive beam sweeping, the base station 105 may use a transmit beam to transmit (e.g., with repetitions) each signal at multiple times within the same resource set so that the UE 110 can sweep through receive beams in multiple transmission instances.

For example, if the base station 105 has a set A of N transmit beams and the UE 110 has a set of M receive beams, the signal may be transmitted on each of the N transmit beams M times so that the UE 110 may receive M instances of the signal per transmit beam. In other words, for each transmit beam of the base station 105, the UE 110 may perform beam sweeping through the receive beams of the UE 110.

In this way, base station 105 may enable the UE 110 to measure a signal on different transmit beams using different receive beams to support selection of base station 105 transmit beam(s)/UE 110 receive beam(s) beam pair(s). In some aspects, the UE 110 may report the measurements to the base station 105 to enable the base station 105 to select one or more beam pairs for communication between the base station 105 and the UE 110. In some aspects, the base station 105 may determine the set B of beams based on the one or more selected beam pairs.

As shown by reference number 120, the base station 105 may conduct beam sweeping based on the set B of beams. In some aspects, a set of signals (e.g., CSI-RSs or SSBs, among other examples) may be configured to be transmitted from the base station 105 to the UE 110. In some aspects, the signals may be configured to be aperiodically transmitted by the base station 105. For example, the base station 105 may transmit, and the UE 110 may receive, DCI scheduling the transmission of the signals.

In some aspects, as shown in FIG. 1B, the set B of beams may be a subset of the set A of beams. In some aspects, the set B of beams may be different from the set A of beams. In some aspects, the base station 105 may transmit one or more signals using each transmit beam of the set B of beams.

In some aspects, the UE 110 may measure each signal using a single (e.g., same) receive beam (e.g., determined based on the measurements performed in connection with the base station 105 conducting beam sweeping via the set A of beams). For example, as shown in FIG. 1A, and by reference number 125, the UE 110 may calculate a set of L1-RSRPs based on the signals transmitted by the base station 105 via the set B of beams.

As shown by reference number 130, the UE 110 may predict a best transmit beam based on the set of L1-RSRPs calculated for the set B of beams. In some aspects, the UE 110 may predict the best transmit beam from the set A of beams. In some aspects, the UE 110 may utilize automated intelligence (AI) and/or machine learning (ML) (referred to collectively and individually as a “model”) to predict the best transmit beam from the set A of beams.

As shown in FIG. 1B, the UE 110 may include, or be associated with a model 135. In some aspects, the model 135 may be trained to predict, based on the set of L1-RSRPs calculated for the set B of beams, a respective L1-RSRP for each beam that is included in the set A of beams and is not included in the set B of beams (e.g., the beams indicated using dashed lines in FIG. 1B) and/or a best transmit beam from the set A of beams. In some aspects, the model 135 may be trained using back propagation and a pre-defined loss function.

In some aspects, the model 135 may include a input layer 135-1 and an output layer 135-2 connected via one or more layers of a neural network. In some aspects, the input layer 135-1 may be configured to receive the L1-RSRPs determined for the set B of beams as inputs. For example, a dimension of the input layer 135-1 may be equal to a quantity of beams included in the set B of beams.

In some aspects, the model 135 may process the set of L1-RSRPs calculated for the set B of beams and may output a result via the output layer 135-2. In some aspects, a dimensionality of the output layer 135-2 is equal to a quantity of beams included in the set A of beams. In some aspects, a position of a node included in the output layer 135-2 relative to other nodes included in the output layer 135-2 may correspond to a position of beam included in the set A of beams relative to other beams included in the set A of beams.

As an example, a first node of the output layer 135-2 may output information associated with a first beam of the set A of beams, a second node of the output layer 135-2 may output information associated with a second beam of the set A of beams, and a third node of the output layer 135-2 may output information associated with a third beam of the set A of beams. The second beam may be spatially oriented between the first beam and the third beam. The second node may be positioned between the first node and the third node of the output layer 135-2 based on the second beam being spatially oriented between the first beam and the third beam.

In some aspects, the model 135 may output a predicted L1-RSRP for each beam included in the set A of beams. For example, each node of the output layer 135-2 may output information indicating an L1-RSRP predicted for a beam having a position relative to other beams corresponding to a position of the node relative to the other nodes.

In these aspects, the UE 110 may determine the best transmit beam based on the predicted L1-RSRPs. For example, the UE 110 may determine that the best transmit beam corresponds to a beam for which the highest L1-RSRP was predicted relative to the other beams.

In some aspects, the model 135 may be configured to output information indicating a best transmit beam. For example, the model 135 may be configured to set an output of a node associated with a highest L1-RSRP to a first value (e.g., 1) and to set an output of all other nodes to a second value (e.g., 2). In these aspects, the UE 110 may determine the best transmit beam based on a position of a node associated with an output corresponding to the first value.

Additionally, or alternatively, the base station 105 may transmit determine the best transmit beam information. For example, the UE 110 may transmit information indicating the set of L1-RSRPs calculated for the set B of beams to the base station 105 and the base station 105 may utilize a model to determine the best transmit beam in a manner similar to that described above.

As shown in FIG. 1A, and by reference number 140, the UE 110 may transmit, and the base station 105 may receive, best transmit beam information. In some aspects, the best transmit beam information may include information indicating the best transmit beam determined by the UE 110, the set of L1-RSRPs measured for the set B of beams, and/or the set of L1-RSRPs predicted by the model 135.

As shown by reference number 145, the base station 105 may select the best transmit beam for transmitting data to the UE 110. For example, the base station 105 may determine the best transmit beam based on the best transmit beam information provided by the UE 110. The base station 105 may select a transmit beam for transmitting signals to the UE 110 corresponding to the best transmit beam indicated in the best beam information. As shown by reference number 150, the base station 105 may transmit one or more signals to the UE 110 via the best transmit beam.

As indicated above, FIGS. 1A and 1B are provided as an example. Other examples may differ from what is described with regard to FIGS. 1A and 1B. The number and arrangement of devices shown in FIGS. 1A and 1B are provided as an example. In practice, there may be additional devices, fewer devices, different devices, or differently arranged devices than those shown in FIGS. 1A and 1B. Furthermore, two or more devices shown in FIGS. 1A and 1B may be implemented within a single device, or a single device shown in FIGS. 1A and 1B may be implemented as multiple, distributed devices. Additionally, or alternatively, a set of devices (e.g., one or more devices) shown in FIGS. 1A and 1B may perform one or more functions described as being performed by another set of devices shown in FIGS. 1A and 1B.

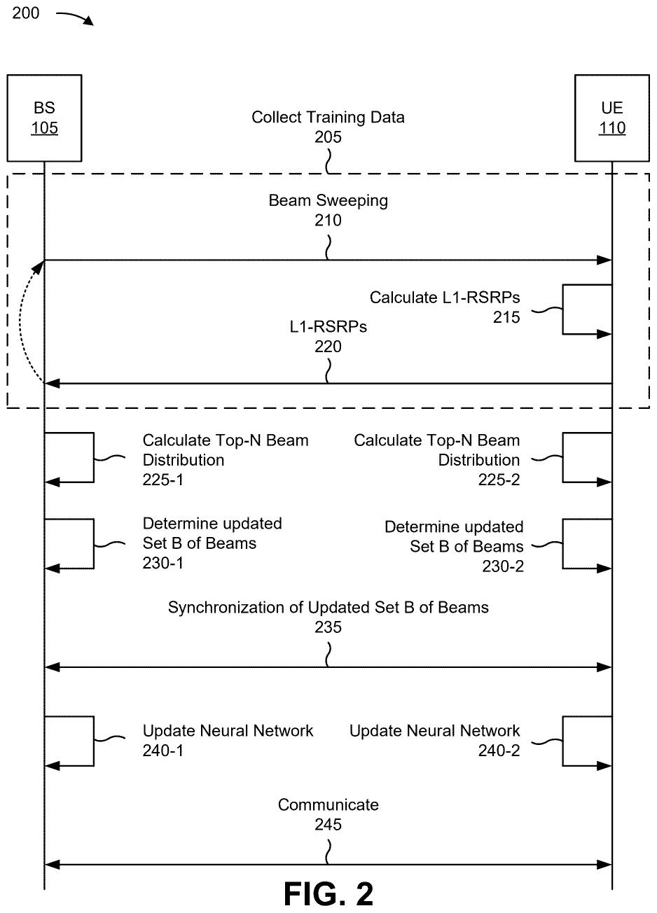

FIG. 2 is a diagram of an example implementation 200 associated with beam management. As shown in FIG. 2, example implementation 200 includes a base station 105 and a UE 110. These devices are described in more detail below in connection with FIG. 5 and FIG. 6.

In some aspects, prior to the operations described below, the base station 105 and/or the UE 110 may determine a set B of beams. For example, the base station 105 and/or the UE 110 may determine a set B of beams in a manner similar to that described above with respect to FIGS. 1A and 1B.

In some aspects, the base station 105 and/or the UE 110 include a model (e.g., a model 135) for determining and/or updating the set B of beams. In some aspects, the base station 105 may include a first model that determines or updates the set B of beams based on a first set of L1-RSRPs determined by the UE 110. Additionally, or alternatively, the UE 110 may include a second model that determines or updates the set B of beams based on a second set of L1-RSRPs determined by the UE 110. In some aspects, the first set of L1-RSRPs may be the same as the second set of L1-RSRPs. In other aspects, the first set of L1-RSRPs may be different from the second set of L1-RSRPs.

In some aspects, as shown by reference number 205, the base station 105 and/or the UE 110 may collect training data for training the model (e.g., the first model and/or the second model) to update the set B of beams. As used herein, “model” may refer to the first model and/or the second model unless specifically indicated otherwise.

In some aspects, the first model may be the same as the second model. For example, a set of coefficients or weights utilized by the first model may be the same as a set of coefficients or weights utilized by the second model. In some aspects, the first model may be different from the second model. For example, the set of coefficients or weights utilized by the first model may be different from the set of coefficients or weights utilized by the second model.

In some aspects, the base station 105 and/or the UE 110 may collect the training data based on determining to update the model. In some aspects, the base station 105 and/or the UE 110 may determine to update the model based on an occurrence of an event.

In some aspects, the event may be associated with a change in a characteristic (e.g., an RSRP, a signal-to-noise ratio (SNR), a throughput, and/or a data rate, among other examples) of a beam included in the set B of beams. For example, the base station 105 and/or the UE 110 may determine to update the model based on a change in a characteristic of a beam included in the set B of beams satisfying a threshold.

In some aspects, the event may be associated with a transmission and/or reception of an negative acknowledgment (NACK). For example, the base station 105 may determine to update the first model (and/or to cause the UE 110 to update the second model) based on a quantity of NACKs received from the UE 110 (and/or failing to receive a quantity of acknowledgments (ACKs)) satisfying (e.g., being greater than or equal to) a threshold. As another example, the UE 110 may determine to update the second model (and/or to cause the base station 105 to update the first model) based on a quantity of NACKs transmitted to the base station 105 satisfying a threshold.

In some aspects, the event may be associated with receiving an indication to update the model. For example, the base station 105 may determine to update the first model based on receiving an indication from the UE 110 (e.g., an indication transmitted based on a change in a characteristic of a beam included in the set B of beams and/or a quantity of NACKs transmitted by the UE 110 satisfying a threshold). As another example, the UE 110 may determine to update the second model based on receiving an indication to update the model from the base station 105 (e.g., an indication transmitted based on a change in a characteristic of a beam included in the set B of beams, a quantity of NACKs transmitted by the UE 110 satisfying a threshold, and/or failing to receive a quantity of ACKs).

In some aspects, the base station 105 and/or the UE 110 may determine to update the model based on an expiration of a time period. For example, the base station 105 and/or the UE 110 may be configured to periodically update the model and the base station 105 and/or the UE 110 may determine to update the model based on an expiration of a time period corresponding to a periodicity at which the model is to be updated.

In some aspects, the base station 105 and/or the UE 110 may determine to update the model based on a change in a location of the UE 110. For example, the base station 105 and/or the UE 110 may determine to update the model based on a difference between a current location of the UE 110 and a previous location of the UE 110 (e.g., a location at which the current set B of beams were determined) satisfying a threshold.

In some aspects, the difference between the current location of the UE 110 and the previous location of the UE 110 corresponds to a straight line distance between the current location of the UE 110 to the previous location of the UE 110. In some aspects, the difference between the current location of the UE 110 and the previous location of the UE 110 is determined relative to the base station 105. For example, the difference between the current location of the UE 110 and the previous location of the UE 110 may correspond to change in a distance at which the UE 110 is from the base station 105.

As shown by reference number 210, the base station 105 may conduct beam sweeping based on the base station 105 and/or the UE 110 determining to update the model. In some aspects, the base station 105 may conducting beam sweeping using the set B of beams. For example, the base station 105 may conduct beam sweeping using the set A of beams or the set B of beams in a manner similar to that described above with respect to FIGS. 1A and 1B.

As shown by reference number 215, the UE 110 may calculate a set of L 1-RSRPs for the set A of beams based on the beam sweeping conducted by the base station 105. In some aspects, the base station 105 may calculate the set of L1-RSRPs for the set A of beams in a manner similar to that described above with respect to FIGS. 1A and 1B.

In some aspects, as shown by reference number 220, the UE 110 may transmit, and the base station 105 may receive, information indicating the set of L1-RSRPs. In some aspects, the UE 110 may transmit the information indicating the set of L1-RSRPs to enable the base station 105 to update the first model.

In some aspects, the training data may include multiple sets of L1-RSRPs. In some aspects, the base station 105 may continue to conduct beam sweeping until multiple different sets of L1-RSRPs are determined by the UE 110 and/or received by the base station 105. In some aspects, the base station 105 may continue to conduct beam sweeping until a quantity of different sets of L1-RSRPs determined by the UE 110 and/or received by the base station 105 satisfies (e.g., is greater than or equal to) a threshold. Additionally, or alternatively, the base station 105 may continue to conduct beam sweeping for a configured amount of time.

As shown by reference numbers 225-1 and 225-2, the base station 105 and/or the UE 110 may calculate a top-N (where N is an integer that is greater than or equal to one) beam distribution based on the set of L1-RSRPs. In some aspects, the top-N beams may include a set of N beams having an L1-RSRP that is higher than an L1-RSRP associated with beams that are not included in the set of N beams. In some aspects, the base station 105 and/or the UE 110 may determine the top-N beam distribution for each set of L1-RSRPs determined by the UE 110.

In some aspects, the base station 105 and/or the UE 110 may determine a quantity of times that each beam, of the set A of beams, was included in the top-N beams determined for each set of L1-RSRPs. For example, if the UE 110 determines five sets of L1-RSRPs, the base station 105 and/or the UE 110 may determine a quantity (e.g., 0, 1, 2, 3, 4, or 5) of times that each beam was included in the top-N beams determined for each of the five sets of L1-RSRPs.

In some aspects, the base station 105 and/or the UE 110 may determine a top-N probability for each beam included in the set A of beams. In some aspects, the top-N probability determined for a beam may indicate a likelihood that the beam will be in the top-N beams. In some aspects, the top-N probability for a beam may be determined based on dividing the quantity of times that the beam was in the top-N beams by the total quantity of sets of L1-RSRPs. As an example, if five sets of L1-RSRPs were determined by the UE 110 and a beam was included in the top-N beams for four of the five sets, the base station 105 and/or the UE 110 may determine that the top-N probability for the beam is 80% (e.g., (4/5)×100).

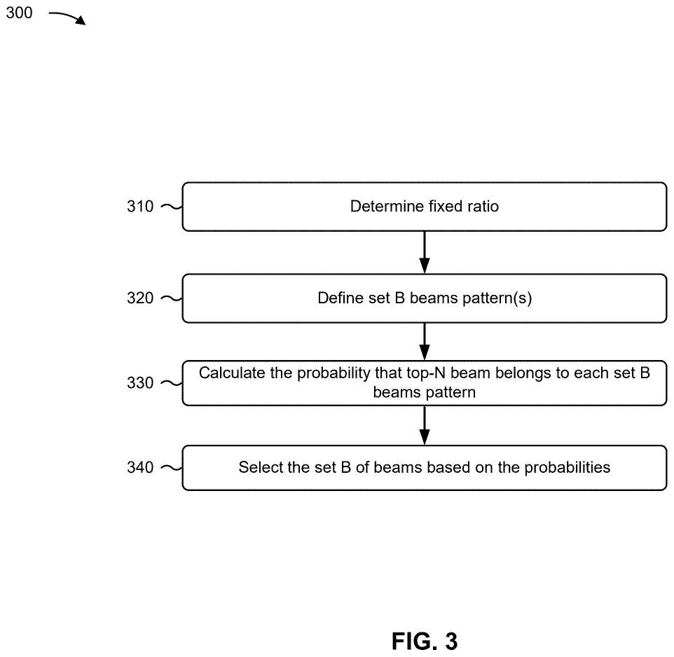

As shown by reference numbers 230-1 and 230-2, the base station 105 and/or the UE 110 may determine an updated set B of beams based on the top-N beam distribution. In some aspects, the base station 105 and/or the UE 110 may determine the updated set B of beams based on a fixed ratio of a quantity of beams included in the set B of beams to a quantity of beams included in the set A of beams, as described in greater detail below with respect to FIG. 3. Stated differently, in cases where the quantity of beams included in the set A of beams is constant or fixed, a quantity of beams included in the updated set B of beams will be the same as the quantity of beams included in the initial set B of beams (e.g., the set B of beams being updated).

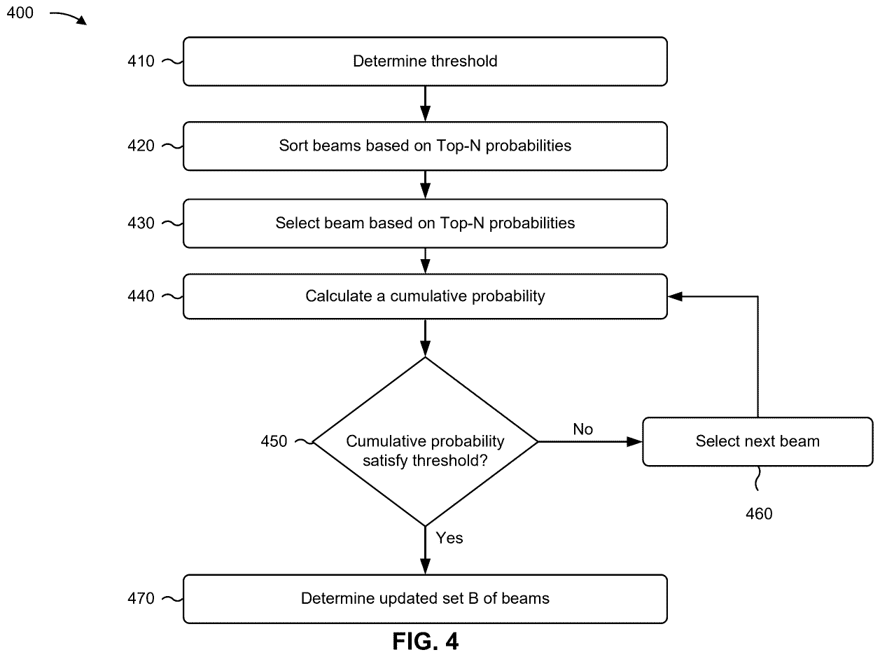

In some aspects, the base station 105 and/or the UE 110 may determine the updated set B of beams based on a flexible ratio of a quantity of beams included in the set B of beams to a quantity of beams included in the set A of beams, as described in greater detail below with respect to FIG. 4. Stated differently, in cases where the quantity of beams included in the set A of beams is constant or fixed, a quantity of beams included in the updated set B of beams will be the same as, or different from, the quantity of beams included in the initial set B of beams (e.g., the set B of beams being updated).

As shown by reference number 235, the base station 105 and the UE 110 may perform a synchronization process to synchronize the updated set B of beams. In some aspects, the synchronization process may include communication information identifying the updated set B of beams between the base station 105 and the UE 110.

In some aspects, the information identifying the updated set B of beams may include a pattern ID (described below with respect to FIG. 4). In some aspects, the information identifying the updated set B of beams may include an identifier associated with each beam included in the updated set B of beams.

In some aspects, the base station 105 may determine the updated set B of beams. In these aspects, the base station 105 may send information indicating the updated set B of beams to the UE 110 to synchronize the updated set B of beams.

In some aspects, the base station 105 may determine the updated set B of beams. In these aspects, the UE 110 may transmit the information indicating the updated set B of beams to the base station 105 to synchronize the updated set of set B of beams.

In some aspects, the base station 105 and the UE 110 may determine the updated set B of beams. In these aspects, at least the UE 110 may transmit information indicating the updated set B of beams to the base station 105. In some aspects, the updated set B of beams determined by the UE 110 may be the same as the updated set of set B of beams determined by the base station 105 and the synchronization process may be complete based on the base station 105 determining that the updated set B of beams determined by the UE 110 is the same as the updated set of set B of beams determined by the base station 105.

In some aspects, the updated set B of beams determined by the UE 110 may be different from the updated set of set B of beams determined by the base station 105. In these aspects, the base station 105 may synchronize the updated set B of beams by modifying the updated set B of beams determined by the base station 105 to be the same as the updated set B of beams determined by the UE 110.

In some aspects, the base station 105 may modify the set B of beams determined by the base station 105 (rather than the UE 110 modifying the set B of beams determined by the UE 110) based on the set of L1-RSRPs being determined by the UE 110. For example, the base station 105 may determine that an accuracy associated with the second model is higher than an accuracy associated with the first model based on the UE 110 utilizing a set of L1-RSRPs that are measured by the UE 110 (rather than utilizing a set of L1-RSRPs measured by another device (e.g., the UE 110) and transmitted to the base station 105).

As shown by reference numbers 240-1 and 240-2, the base station 105 and/or the UE 110 may update a neural network of the model based on the updated set B of beams. In some aspects, the base station 105 and/or the UE 110 may update the neural network by setting the L1-RSRPs as the inputs to the model and setting a best beam of the updated set B of beams (e.g., a beam having a highest L1-RSRP relative to the L1-RSRPs of the other beams included in the set B of beams) as a label. The model may process the input set of L1-RSRPs and may modify one or more weights or coefficients to update the model based on the labeled best beam and the input set of L 1-RSRPs. As shown by reference number 245, the base station 105 and the UE 110 may communicate based on updating the set B of beams.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

FIG. 3 illustrates an example process 300 for determining an updated set B of beams based on a fixed ratio of a quantity of beams included in the set B of beams to a quantity of beams included in the set A of beams.

As shown by reference number 310, a device (e.g., a base station 105 and/or a UE 110) may determine a fixed ratio of a quantity (X) of beams included in a set B of beams to a quantity (Y) of beams included in a set A of beams. Stated differently, the ratio (X/Y) may be a fixed or constant value. In some aspects, the device may determine the fixed ratio by dividing the quantity of beams included in the set A of beams by the quantity of beams included in the set B of beams.

As shown by reference number 320, the device may define one or more set B beams pattern based on the fixed ratio. In some aspects, a set B beams pattern may be a combination of beams included in the set A of beams. For example, the set A of beams may include eight beams (e.g., beams 1 through 8) and a set B beams pattern may include beam 1, beam 3, and beam 5 with the quantity of beams included in the set B beams pattern being dependent upon the quantity of beams included in the set A of beams and the fixed ratio.

In some aspects, the quantity of beams included in a set A of beams may be fixed. For example, the set A of beams may be a preconfigured set of beams that remains constant for a time period and, therefore, the quantity of beams included in the set A of beams may remain the same or be fixed during the time period. In these aspects, the quantity of beams included in a set B beams pattern may be the same as the quantity of beams included in the current set B of beams during the time period.

In some aspects, the quantity of beams included in the set A of beams may not be fixed (or may change from one fixed quantity to another fixed quantity based on, for example, a change in network conditions). In these aspects, the quantity of beams included in a set B beams pattern (and therefore in an updated set B of beams) may change in a proportional manner such that the ratio (X/Y) remains the same.

As an example, initially, the set A of beams may include six beams, the set B of beams may include three beams, and the fixed ratio may be 1/2. At a time that the updated set of set B of beams is determined, the set A of beams may include eight beams. Based on the ratio (1/2) of the quantity of beams included in the set B of beams to the quantity of beams included in the set A of beams and based on the quantity of beams included in the set A of beams being four, the device (e.g., a base station 105 and/or a UE 110) may determine that the updated set B of beams (and therefore the quantity of beams included in each set B beams pattern) includes four beams to cause the ratio of the quantity of beams included in the set B of beams to the quantity of beams in a set A of beams to remain at 1/2.

In some aspects, the beams included in the set B beams patterns may be selected based on a set of criteria. For example, the beams included in the set B beams patterns may be selected sequentially, based on whether a beam identifier (or a portion of a beam identifier) associated with each beam included in the set A of beams is an odd or an even numbered value, or according to a formula or methodology for selecting the beams, among other examples.

In some aspects, beams included in the set B beams patterns may be randomly selected. In some aspects, the beams included in the set B beams patterns may be preconfigured (e.g., by the base station 105). In some aspects, each preconfigured set B beams pattern may be associated with a respective identifier. By associating each preconfigured set B beams pattern with a respective identifier, the device may indicate the updated set B of beams by transmitting the identifier associated with the set B beams pattern corresponding to the updated set B of beams. In this way, an amount of data and/or signaling communicated between an base station 105 and a UE 110 to indicate the updated set B of beams may be reduced relative to transmitting information identifying each beam included in the updated set B of beams.

As shown by reference number 330, the device may determine a probability that a beam included in the top-N beams is included in each of the one or more set B beams patterns. In some aspects, the device may determine the probability that a beam included in the top-N beams is included in each of the one or more set B beams patterns based on the top-N beam distribution.

For example, for each beam included in a set B beams pattern, the device may determine a probability of the beam being in the top-N beam distribution, as described above with respect to FIGS. 1A and 1B. The device may determine a probability that a beam included in the top-N beams is included in the set B beams pattern based on the probabilities determined for each beam. For example, the device may determine an average of the probabilities determined for each beam and may determine that the probability that a beam included in the top-N beams is included in the set B beams pattern corresponds to the average of the probabilities.

As shown by reference number 340, the device may select the updated set B of beams based on the probability that a beam included in the top-N beams is included in each of the one or more set B beams patterns. For example, the device may select the set B beams pattern for which the highest probability was determined and may select the updated set B of beams as the beams corresponding to the selected set B beams pattern.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

FIG. 4 illustrates an example process 400 for determining an updated set B of beams based on a flexible ratio of a quantity of beams included in the set B of beams to a quantity of beams included in the set A of beams.

In some aspects, a flexible ratio of a quantity of beams included in the set B of beams to a quantity of beams included in the set A of beams may correspond to a scenario in which a quantity of beams included in the updated set B of beams is allowed to change even when the quantity of beams included in the set A of beams remains the same.

As shown by reference number 410, a device (e.g., an base station 105 and/or a UE 110) may determine a threshold. In some aspects, the threshold may correspond to a minimum cumulative probability associated with a set of beams to be included in the updated set B of beams, as described in greater detail below. In some aspects, a value of the threshold (γ) may comprise a value from zero through one (e.g., (γ∈(0,1))).

In some aspects, the value of the threshold may be determined by a base station (e.g., a base station 105). In some aspects, the value of the threshold may be determined by a UE (e.g., a UE 110). In some aspects, the value of the threshold may be determined based on a negotiation between the base station and the UE.

In some aspects, the threshold may be selected to achieve a desired tradeoff between system performance and an amount of resources used to determine the updated set B of beams. For example, a threshold set to a first value may result in a greater quantity of beams being included in the set B of beams relative to a threshold set to a second value that is a lower value relative to the first value. However, setting the threshold to the first value may result in a greater amount of computational resources being utilized to determine the set B of beams relative to an amount of computational resources used to determine the set B of beams when the threshold is set to the second value.

As shown by reference number 420, the device may sort the beams included in the set A of beams based on the top-N probability determined for each beam. In some aspects, the device may generate an ordered list of beams based on the top-N probability determined for each beam. For example, the device may sort the beams included in the set A of beams starting with a first beam associated with a highest top-N probability relative to the other beams, a second beam associated with a second highest top-N probability relative to the other beams, and continuing in a similar manner until all of the beams that are included in the set A of beams are included in the order list of beams.

As shown by reference number 430, the device may select a beam for the set B of beams based on the top-N probabilities. In some aspects, the device may select a beam that is associated with the highest top-N probability relative to the other beams (e.g., the first beam).

As shown by reference number 440, the device may determine a cumulative probability associated with the set B of beams. In some aspects, the device may determine the cumulative probability associated with the set B of beams based on a sum of the top-N probability associated with each beam that has been selected for the set B of beams. In some aspects, the device may determine the cumulative probability associated with the set B of beams as corresponding to the top-N probability associated with the beam that has been selected for the set B of beams (e.g., the first beam) based on the selected beam being the only beam currently selected for the set B of beams.

As shown by reference number 450, the device may determine whether the cumulative probability associated with the set B of beams satisfies (e.g., is greater than or equal to) the threshold. In some aspects, the cumulative probability associated with the set B of beams may fail to satisfy the threshold. For example, the cumulative probability associated with the set B of beams may be less than the threshold.

In these aspects, as shown by reference number 460, the device may select a next beam for the set B of beams based on the top-N probabilities. For example, the device may select a beam associated with a second highest top-N probability relative to the beams (e.g., the second beam). As shown in FIG. 4, process 400 may return to calculating a cumulative probability associated with the set B of beams based on selecting the next beam and determining whether the cumulative probability satisfies the threshold.

In some aspects, the cumulative probability associated with the set B of beams (e.g., the first beam and the second beam) may satisfy the threshold. In these aspects, as shown by reference number 470, the device may determine the updated set B of beams as corresponding to the selected beams (e.g., the first beam and the second beam) based upon which the cumulative probability was determined.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

FIG. 5 is a diagram of an example environment 500 in which systems and/or methods described herein may be implemented. As shown in FIG. 5, environment 500 may include a base station 105, a UE 110, and a network 510. Devices of environment 500 may interconnect via wired connections, wireless connections, or a combination of wired and wireless connections.

Base station 105 includes one or more devices capable of communicating with a UE using a cellular radio access technology (RAT). For example, base station 105 may include a base transceiver station, a radio base station, a node B, an evolved node B (eNB), a gNB, a base station subsystem, a cellular site, a cellular tower (e.g., a cell phone tower or a mobile phone tower), an access point, a TRP, a radio access node, a macrocell base station, a microcell base station, a picocell base station, a femtocell base station, or a similar type of device. Base station 105 may transfer traffic between a UE (e.g., using a cellular RAT), other base stations 105 (e.g., using a wireless interface or a backhaul interface, such as a wired backhaul interface), and/or network 510. Base station 105 may provide one or more cells that cover geographic areas. Some base stations 105 may be mobile base stations. Some base stations 105 may be capable of communicating using multiple RATs.

In some implementations, base station 105 may perform scheduling and/or resource management for UEs covered by base station 105 (e.g., UEs covered by a cell provided by base station 105). In some implementations, base stations 105 may be controlled or coordinated by a network controller, which may perform load balancing and/or network-level configuration. The network controller may communicate with base stations 105 via a wireless or wireline backhaul. In some implementations, base station 105 may include a network controller, a self-organizing network (SON) module or component, or a similar module or component. In other words, a base station 105 may perform network control, scheduling, and/or network management functions (e.g., for other base stations 105 and/or for uplink, downlink, and/or sidelink communications of UEs covered by the base station 105). In some implementations, base station 105 may include a central unit and multiple distributed units. The central unit may coordinate access control and communication with regard to the multiple distributed units. The multiple distributed units may provide UEs and/or other base stations 105 with access to network 510.

In some implementations, base station 105 may be capable of multiple-input and multiple-output (MIMO) communication (e.g., beamformed communication). In some implementations, base station 105 may include a calibration component for phase calibration of signals produced or received by base station 105, as described elsewhere herein. In a testing scenario, one or more antenna elements (e.g., an antenna array) of base station 105 may be disconnected, and base station 105 may be connected to a test panel, as described elsewhere herein.

UE 110 may include one or more devices capable of communicating with base station 105 and/or a network (e.g., network 510). For example, UE 110 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. UE 110 may be capable of communicating using uplink (e.g., UE to base station) communications, downlink (e.g., base station to UE) communications, and/or sidelink (e.g., UE-to-UE) communications. In some implementations, UE 110 may include a machine-type communication (MTC) UE, such as an evolved or enhanced MTC (eMTC) UE. In some implementations, UE 110 may include an Internet of Things (IoT) UE, such as a narrowband IoT (NB-IoT) UE.

Network 510 includes one or more wired and/or wireless networks. For example, network 510 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks.

The quantity and arrangement of devices and networks shown in FIG. 5 are provided as one or more examples. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with beam management. The device 600 corresponds to one or more of the base station 105 and/or the UE 110. In some implementations, the base station 105 and/or the UE 110 include one or more devices 600 and/or one or more components of the device 600. In the example shown in FIG. 6, the device 600 includes a bus 610, a processor 620, a memory 630, an input component 640, an output component 650, and/or a communication component 660.

The bus 610 includes one or more components that enable wired and/or wireless communication among the components of the device 600. The bus 610 couples together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 includes a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 includes one or more processors capable of being programmed to perform one or more operations or processes described elsewhere herein.

The memory 630 includes volatile and/or nonvolatile memory, such as random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). In some implementations, the memory 630 is a non-transitory computer-readable medium. The memory 630 stores information, one or more instructions, and/or software (e.g., one or more software applications) related to the operation of the device 600. In some implementations, the memory 630 includes one or more memories that are coupled (e.g., communicatively coupled) to one or more processors (e.g., processor 620), such as via the bus 610. Communicative coupling between a processor 620 and a memory 630 enables the processor 620 to read and/or process information stored in the memory 630 and/or to store information in the memory 630.

The input component 640 enables the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 enables the device 600 to provide output, such as via a display, a speaker, and/or a light-emitting diode. The communication component 660 enables the device 600 to communicate with other devices via a wired connection and/or a wireless connection. For example, the communication component 660 may include a receiver, a transmitter, a transceiver, a modem, a network interface card, and/or an antenna.

In some implementations, the device 600 performs one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

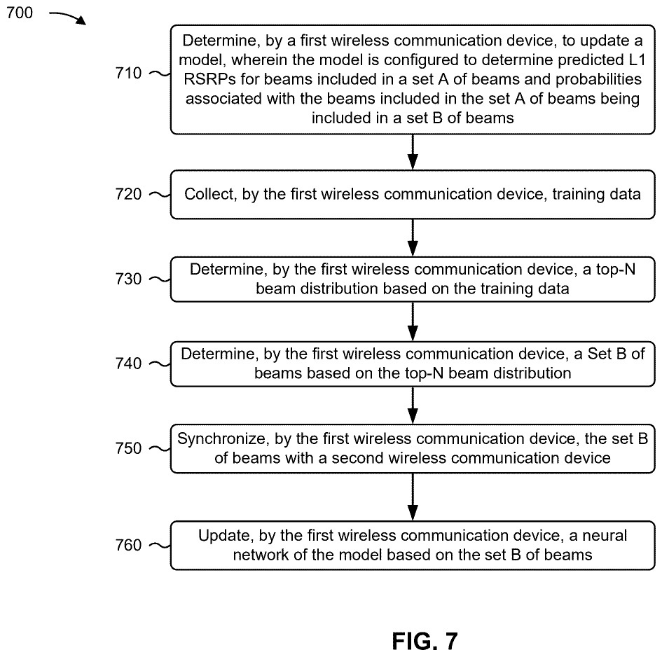

FIG. 7 is a flowchart of an example process 700 associated with beam management. One or more process blocks of FIG. 7 are performed by a first wireless communication device (e.g., a base station 105 and/or a UE 110) and/or by another device or a group of devices separate from or including the first wireless communication device. Additionally, or alternatively, one or more process blocks of FIG. 7 may be performed by one or more components of device 600, such as processor 620, memory 630, input component 640, output component 650, and/or communication component 660.

As shown in FIG. 7, process 700 includes determining to update a model, wherein the model is configured to determine predicted L1-RSRPs for beams included in a set A of beams and probabilities associated with the beams included in the set A of beams being included in a set B of beams (block 710). For example, the first wireless communication device may determine to update a model, wherein the model is configured to determine predicted L1-RSRPs for beams included in a set A of beams and probabilities associated with the beams included in the set A of beams being included in a set B of beams, as described above.

As further shown in FIG. 7, process 700 includes collecting training data (block 720). For example, the first wireless communication device may collect training data, as described above.

As further shown in FIG. 7, process 700 includes determining a top-N beam distribution based on the training data (block 730). For example, the first wireless communication device may determine a top-N beam distribution based on the training data, as described above.

As further shown in FIG. 7, process 700 includes determining the set B of beams based on the top-N beam distribution (block 740). For example, the first wireless communication device may determine the set B of beams based on the top-N beam distribution, as described above.

As further shown in FIG. 7, process 700 includes synchronizing the set B of beams with a second wireless communication device (block 750). For example, the first wireless communication device may synchronize the set B of beams with a second wireless communication device, as described above.

As further shown in FIG. 7, process 700 includes updating a neural network of the model based on the set B of beams (block 760). For example, the first wireless communication device may update a neural network of the model based on the set B of beams, as described above.

Process 700 may include additional aspects, such as any single aspect or any combination of aspects described below and/or in connection with one or more other processes described elsewhere herein.

In a first aspect, a ratio of a quantity of beams included in the set A of beams and a quantity of beams included in the set B of beams is a fixed ratio.

In a second aspect, alone or in combination with the first aspect, determining the set B of beams comprises determining the fixed ratio, defining a group of beam patterns for the set B of beams based on the fixed ratio, wherein each beam pattern, of the group of beam patterns, corresponds to a respective group of beams included in the set A of beams, determining, for each beam pattern, a probability that a beam, included in the set A of beams and having a highest reference signal received power, is included in the beam pattern, and selecting the set B of beams based on the probability determined for each beam pattern.

In a third aspect, alone or in combination with one or more of the first and second aspects, a ratio of a quantity of beams included in the set A of beams and a quantity of beams included in the set B of beams is a variable ratio.

In a fourth aspect, alone or in combination with one or more of the first through third aspects, determining the set B of beams comprises determining a probability threshold associated with a quantity of beams to be included in the set B of beams, determining, for each beam of the set A of beams, a probability that the beam has a highest reference signal received power relative to other beams of the set A of beams, ordering, based on the probability determined for each beam, the set A of beams to generate an ordered list of beams, wherein a first beam, of the ordered list of beams, is associated with a highest probability relative to the other beams and a last beam, of the ordered list of beams is associated with a lowest probability relative to the other beams, including the first beam in the set B of beams based on the first beam being associated with the highest probability, and including additional beams, from the ordered set of beams, in the set B of beams until a cumulative probability of the set B of beams is greater than or equal to the probability threshold, wherein each additional beam, of the additional beams, is associated with a higher priority than other additional beams that are subsequently included in the set B of beams.

In a fifth aspect, alone or in combination with one or more of the first through fourth aspects, collecting the training data comprises collecting a plurality of sets of data, wherein each set of data, of the plurality of sets of data, includes information indicating an L1 RSRP measured for each beam of the set B of beams.

In a sixth aspect, alone or in combination with one or more of the first through fifth aspects, the first wireless communication device is a base station and the second wireless communication device is a user equipment.

In a seventh aspect, alone or in combination with one or more of the first through sixth aspects, the first wireless communication device is a user equipment and the second wireless communication device is a base station.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
determining, by a first wireless communication device, to update a model, wherein the model is configured to determine predicted layer one (L1) reference signal received powers (RSRPs) for beams included in a set A of beams and probabilities associated with the beams included in the set A of beams being included in a set B of beams;
collecting, by the first wireless communication device, training data;
determining, by the first wireless communication device, a top-N beam distribution based on the training data;
determining, by the first wireless communication device, the set B of beams based on the top-N beam distribution;
synchronizing, by the first wireless communication device, the set B of beams with a second wireless communication device; and
updating, by the first wireless communication device, a neural network of the model based on the set B of beams.

2. The method of claim 1, wherein a ratio of a quantity of beams included in the set A of beams and a quantity of beams included in the set B of beams is a fixed ratio.

3. The method of claim 2, wherein determining the set B of beams comprises:
determining the fixed ratio;
defining a group of beam patterns for the set B of beams based on the fixed ratio, wherein each beam pattern, of the group of beam patterns, corresponds to a respective group of beams included in the set A of beams;
determining, for each beam pattern, a probability that a beam, included in the set A of beams and having a highest reference signal received power, is included in the beam pattern; and
selecting the set B of beams based on the probability determined for each beam pattern.

4. The method of claim 1, wherein a ratio of a quantity of beams included in the set A of beams and a quantity of beams included in the set B of beams is a variable ratio.

5. The method of claim 4, wherein determining the set B of beams comprises:
determining a probability threshold associated with a quantity of beams to be included in the set B of beams;
determining, for each beam of the set A of beams, a probability that the beam has a highest reference signal received power relative to other beams of the set A of beams;
ordering, based on the probability determined for each beam, the set A of beams to generate an ordered list of beams, wherein a first beam, of the ordered list of beams, is associated with a highest probability relative to the other beams and a last beam, of the ordered list of beams is associated with a lowest probability relative to the other beams;
including the first beam in the set B of beams based on the first beam being associated with the highest probability; and
including additional beams, from the ordered set of beams, in the set B of beams until a cumulative probability of the set B of beams is greater than or equal to the probability threshold, wherein each additional beam, of the additional beams, is associated with a higher priority than other additional beams that are subsequently included in the set B of beams.

6. The method of claim 1, wherein collecting the training data comprises:
collecting a plurality of sets of data, wherein each set of data, of the plurality of sets of data, includes information indicating an L1 RSRP measured for each beam of the set B of beams.

7. The method of claim 1, wherein the first wireless communication device is a base station and the second wireless communication device is a user equipment.

8. The method of claim 1, wherein the first wireless communication device is a user equipment and the second wireless communication device is a base station.

9. A first wireless communication device, comprising:
one or more memories; and
one or more processors, coupled to the one or more memories, configured to:
determine to update a model, wherein the model is configured to determine predicted layer one (L1) reference signal received powers (RSRPs) for beams included in a set A of beams and probabilities associated with the beams included in the set A of beams being included in a set B of beams;
collect training data;
determine a top-N beam distribution based on the training data;
determine the set B of beams based on the top-N beam distribution;
synchronize the set B of beams with a second wireless communication device; and
update a neural network of the model based on the set B of beams.

10. The first wireless communication device of claim 9, wherein a ratio of a quantity of beams included in the set A of beams and a quantity of beams included in the set B of beams is a fixed ratio.

11. The first wireless communication device of claim 10, wherein the one or more processors, to determine the set B of beams, are configured to:
determine the fixed ratio;
define a group of beam patterns for the set B of beams based on the fixed ratio, wherein each beam pattern, of the group of beam patterns, corresponds to a respective group of beams included in the set A of beams;
determine, for each beam pattern, a probability that a beam, included in the set A of beams and having a highest reference signal received power, is included in the beam pattern; and
select the set B of beams based on the probability determined for each beam pattern.

12. The first wireless communication device of claim 9, wherein a ratio of a quantity of beams included in the set A of beams and a quantity of beams included in the set B of beams is a variable ratio.

13. The first wireless communication device of claim 12, wherein the one or more processors, to determine the set B of beams, are configured to:
determine a probability threshold associated with a quantity of beams to be included in the set B of beams;
determine, for each beam of the set A of beams, a probability that the beam has a highest reference signal received power relative to other beams of the set A of beams;
order, based on the probability determined for each beam, the set A of beams to generate an ordered list of beams, wherein a first beam, of the ordered list of beams, is associated with a highest probability relative to the other beams and a last beam, of the ordered list of beams is associated with a lowest probability relative to the other beams;
include the first beam in the set B of beams based on the first beam being associated with the highest probability; and
include additional beams, from the ordered set of beams, in the set B of beams until a cumulative probability of the set B of beams is greater than or equal to the probability threshold, wherein each additional beam, of the additional beams, is associated with a higher priority than other additional beams that are subsequently included in the set B of beams.

14. The first wireless communication device of claim 9, wherein the one or more processors, to collect the training data, are configured to:
collect a plurality of sets of data, wherein each set of data, of the plurality of sets of data, includes information indicating an L1 RSRP measured for each beam of the set B of beams.

15. A non-transitory computer-readable medium storing a set of instructions, the set of instructions comprising:
one or more instructions that, when executed by one or more processors of a first wireless communication device, cause the first wireless communication device to:
determine to update a model, wherein the model is configured to determine predicted layer one (L1) reference signal received powers (RSRPs) for beams included in a set A of beams and probabilities associated with the beams included in the set A of beams being included in a set B of beams;
collect training data;
determine a top-N beam distribution based on the training data;
determine the set B of beams based on the top-N beam distribution;
synchronize the set B of beams with a second wireless communication device; and
update a neural network of the model based on the set B of beams.

16. The non-transitory computer-readable medium of claim 15, wherein a ratio of a quantity of beams included in the set A of beams and a quantity of beams included in the set B of beams is a fixed ratio.

17. The non-transitory computer-readable medium of claim 16, wherein the one or more instructions, that cause the first wireless communication device to determine the set B of beams, cause the first wireless communication device to:
determine the fixed ratio;
define a group of beam patterns for the set B of beams based on the fixed ratio, wherein each beam pattern, of the group of beam patterns, corresponds to a respective group of beams included in the set A of beams;
determine, for each beam pattern, a probability that a beam, included in the set A of beams and having a highest reference signal received power, is included in the beam pattern; and
select the set B of beams based on the probability determined for each beam pattern.

18. The non-transitory computer-readable medium of claim 15, wherein a ratio of a quantity of beams included in the set A of beams and a quantity of beams included in the set B of beams is a variable ratio.

19. The non-transitory computer-readable medium of claim 18, wherein the one or more instructions, that cause the first wireless communication device to determine the set B of beams, cause the first wireless communication device to:
determine a probability threshold associated with a quantity of beams to be included in the set B of beams;
determine, for each beam of the set A of beams, a probability that the beam has a highest reference signal received power relative to other beams of the set A of beams;
order, based on the probability determined for each beam, the set A of beams to generate an ordered list of beams, wherein a first beam, of the ordered list of beams, is associated with a highest probability relative to the other beams and a last beam, of the ordered list of beams is associated with a lowest probability relative to the other beams;
include the first beam in the set B of beams based on the first beam being associated with the highest probability; and
include additional beams, from the ordered set of beams, in the set B of beams until a cumulative probability of the set B of beams is greater than or equal to the probability threshold, wherein each additional beam, of the additional beams, is associated with a higher priority than other additional beams that are subsequently included in the set B of beams.

20. The non-transitory computer-readable medium of claim 15, wherein the one or more instructions, that cause the first wireless communication device to collect the training data, cause the first wireless communication device to:
collect a plurality of sets of data, wherein each set of data, of the plurality of sets of data, includes information indicating an L1 RSRP measured for each beam of the set B of beams.
